(19) United States
(12) Patent Application Publication
(10) Pub. No.: US 2010/0294621 A1
(43) Pub. Date: Nov. 25, 2010

(54) Vehicle Conveyor System

(76) Inventor: Dimitrios Kolios, North Bay (CA)

Correspondence Address: Amy E. Rinaldo, 38955 Hills Tech Drive, Farmington Hills, MI, 48331, US

(21) Appl. No.: 12/778,384

(22) Filed: May 12, 2010

Related U.S. Application Data
(63) Continuation-in-part of application No. PCT/CA2008/001990, filed on Nov. 12, 2008.
(60) Provisional application No. 60/987,452, filed on Nov. 13, 2007.

(51) Int. Cl. B65G 43/08; B65G 37/00; B65G 47/00

(52) U.S. Cl. 198/464.1; 198/463.1; 198/469.1

(57) ABSTRACT

Apparatus for use in an area of vehicular traffic is disclosed. The area is of the type having a vehicle receiving area whereat a stream of vehicles arrive, randomly spaced-apart from one another in time and further having a point to which vehicles travel from the vehicle receiving area. The apparatus comprises a transport device adapted to transport vehicles, in use, from the receiving area to the point at independently variable rates of speed to permit vehicles to be turned off at the receiving area while maintaining a flow of vehicles, spaced-apart from one another, to the point. The point can be a pinch point, whereat the speed of vehicular travel is constrained. The apparatus can form part of a drive-through restaurant, wherein the drive-through window defines the pinch point in use.

CROSS-REFERENCE TO RELATED APPLICATION(S)

This application claims the benefit of Patent Cooperation Treaty (PCT) Application No. PCT/CA2008/001990 that was filed on Nov. 12, 2008 and further claims the benefit of U.S. provisional patent application entitled “Vehicle Conveyor System,” having Ser. No. 60/987,452, and filed on Nov. 13, 2007.

### FIELD OF THE INVENTION

The present invention relates to the field of drive-through operations.

### BACKGROUND OF THE INVENTION

Drive-through operations are of substantial importance. For example, in the current restaurant industry, in many restaurants, a large proportion of revenues are derived from drive-through operations.

In a typical drive-through restaurant operation, a roadway passes in close proximity to a restaurant facility having a take-out window. Along the roadway leading to the drive-through window is located a communication device, namely, a combination microphone/speaker. In use, vehicles arriving at the restaurant which are operated by persons desirous of utilizing the drive-through are driven so as to enter a vehicle receiving area which defines the commencement of the roadway and to travel along the roadway to the communication device, whereat an order is presented by the occupants of the vehicle to restaurant staff via the communication device. After the order has been taken, the operator causes the vehicle to travel further down the roadway to the drive-through window, where possession of the food order passes to the vehicle occupant(s) in exchange for compensation. In terms of traffic flow on the roadway, there exists two pinch points. The first is at the communication device, where vehicles remain motionless for a period of time while the order is relayed. The second is at the drive-through window, where vehicles remain motionless while the order is passed to the vehicle and compensation is made. During busy times, it is commonplace for slow-moving queues to form at the first pinch point and at the second pinch point. The queues are problematic from the standpoint of carbon dioxide emissions associated with idling. As well, long queues will cause many vehicle operators to reconsider the use of the drive-through, leading to lost restaurant revenues. Finally, in-queue collisions are not infrequent, and cause complications to the drive-through operators.

### SUMMARY OF THE INVENTION

A drive-through establishment forms one aspect of the invention. This establishment comprises: a facility having a service area; and a transport device for receiving vehicles and conveying same towards the service area, the transport device comprising one or more conveyors. This establishment can further comprise a communication device that moves generally parallel to and in concert with one of the one or more conveyors to permit, in use, an occupant of a vehicle in motion on said one conveyor to communicate with the facility. The communication device can be rail-mounted. The transport device can comprise multiple conveyors, each being independently actuable at an independently-variable rate of speed. The facility can be a retail facility and the service area can be defined by a service window. The retail facility can be a fast-food restaurant and the service window can be a take-out window. The one or more conveyors can be conveyor belts. The facility can be a border crossing and the service area can be defined by a customs booth. The service area can also be defined by a toll booth.

A drive-through establishment forms another aspect of the invention. This establishment is of the type having: a vehicle receiving area whereat a stream of vehicles arrive, randomly spaced-apart from one another in time; and a pinch point to which vehicles travel from the vehicle receiving area and whereat the speed of vehicular travel is constrained. This establishment comprises: a transport device adapted to transport vehicles, in use, from the receiving area to the pinch point at independently variable rates of speed to permit vehicles to be turned off at the receiving area while maintaining a flow of vehicles, spaced-apart from one another, to the pinch point. Sensors can be arrayed at points intermediate the receiving area and the pinch point to detect the locations of vehicles; and a logic controller in communication with the sensors can drive the transport device to avoid collisions of vehicles in transport. The pinch point can be defined by a service window in a retail establishment.

Apparatus for use in an area of vehicular traffic forms another aspect of the invention. The area is of the type having: a vehicle receiving area whereat a stream of vehicles arrive, randomly spaced-apart from one another in time; a first pinch point to which vehicles travel from the vehicle receiving area and whereat the speed of vehicular travel is constrained; and a second pinch point to which vehicles travel from the first pinch point and whereat the speed of vehicular travel is constrained. This apparatus comprises a transport device adapted to transport vehicles from the receiving area to the second pinch point at independently variable rates of speed to permit the vehicles to be turned off at the receiving area while maintaining a flow of vehicles, spaced-apart from one another, to the second pinch point. This apparatus can form part of a drive-through establishment also comprising: a communication device; and a facility having a service window and in communication with the communication device to receive orders therefrom. In the drive-through establishment, the communication device defines the first pinch point and the service window defines the second pinch point. The transport device can comprise more than one conveyor. Each conveyor can be independently actuable at an independently-variable rate of speed. The conveyors can be conveyor belts. The communication device can move generally parallel to and in concert with one of the one or more conveyors to permit, in use, an occupant of a vehicle in motion on said one conveyor to communicate with the facility. The communication device can be rail-mounted. Sensors can be arrayed along the conveyors to detect the locations of vehicles and a logic controller in communication with the sensors can drive the conveyors to avoid collisions of vehicles in transport.

Apparatus for use in an area of vehicular traffic forms another aspect of the invention. The area is of the type having: a vehicle receiving area whereat a stream of vehicles arrive, randomly spaced-apart from one another in time; and a point to which vehicles travel from the vehicle receiving area, wherein the speed of vehicular travel is constrained between the vehicle receiving area and the point. The apparatus comprises a transport device adapted to transport vehicles from the receiving area to the point at independently variable rates of speed to permit the vehicles to be turned off at the receiving area while maintaining a flow of vehicles, spaced-apart from one another, to the point. This apparatus can be used in a construction zone, in a tunnel, on a bridge or in a pedestrian plaza.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings.

### BRIEF DESCRIPTION OF THE DRAWINGS

FIG. 1 is a plan view of a drive-through retail establishment according to an exemplary embodiment of the invention.

FIG. 2 is an elevational view of a portion of the structure of FIG. 1 in the direction of arrow 2 of FIG. 1.

FIG. 3 is a plan view of apparatus according to another exemplary embodiment of the invention.

FIG. 4 is a plan view of apparatus according to another exemplary embodiment of the invention.

FIG. 5 is a perspective view of apparatus according to another exemplary embodiment of the invention.

FIG. 6 is a view similar to FIG. 1 showing another exemplary embodiment of the invention.

FIG. 7 is a plan view of a further exemplary embodiment of the invention.

FIG. 8 is a partial sectional view along 8-8 of FIG. 7.

FIG. 9 is a plan view of a further exemplary embodiment of the invention.

### DETAILED DESCRIPTION

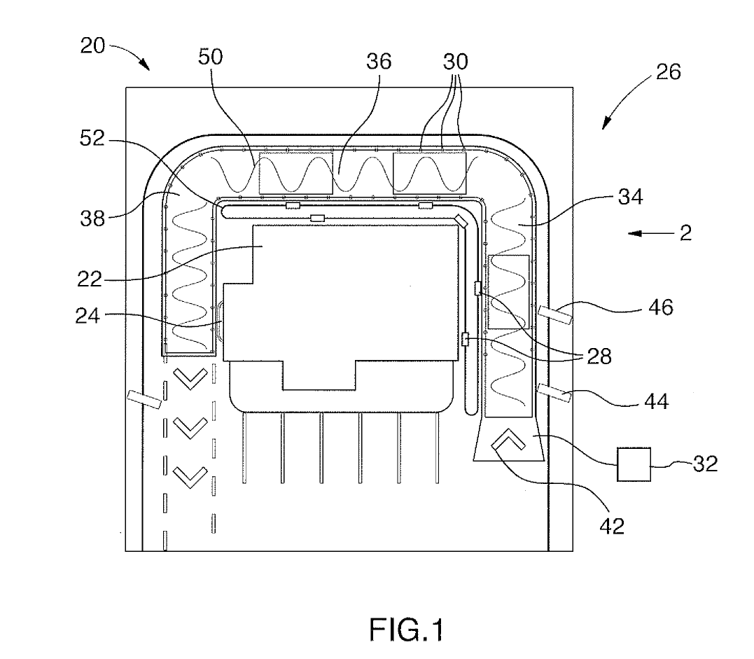

A drive-through retail establishment, specifically, a drive-through restaurant, according to an exemplary embodiment of the invention is shown in plan view in FIG. 1 and designated with general reference numeral 20 and will be seen to comprise, as is conventional, a restaurant facility 22 having a service area 24 in the form of a drive-through window.

The drive-through restaurant 20 additionally comprises a transport device 26, a plurality of communication devices 28, sensors 30 and a logic controller 32.

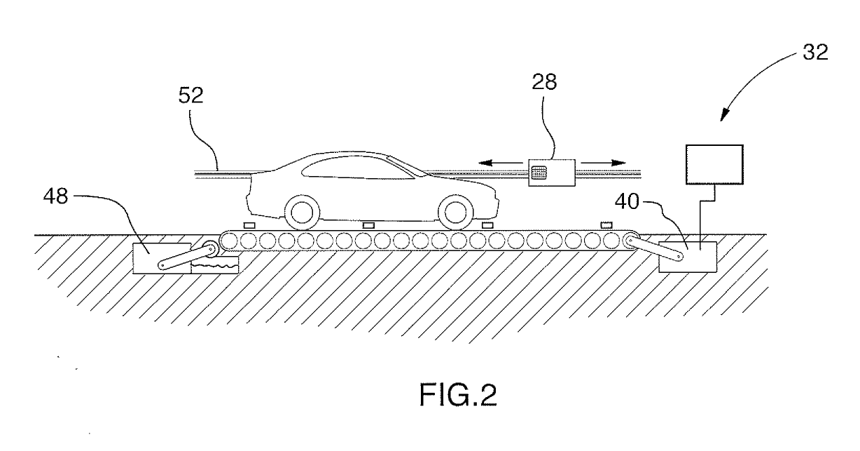

The illustrated transport device 26 comprises multiple conveyors, to wit, three conveyors 34, 36, 38 in the form of conveyor belts. Each conveyor 34, 36, 38 is independently actuable at an independently-variable rate of speed. Conveyor 34 extends from a vehicle receiving area 42 in the parking lot of the restaurant past a “turn off vehicle” sign 44 and past a menu board 46. Conveyor 38 extends past the drive-through window 24. Conveyor 36 extends between the first 34 and third 38 conveyors. Collectively, the conveyors 34, 36, 38 are adapted to receive vehicles and convey same towards and past the drive-through window 24. To utilize the drive-through, the operator of a vehicle is merely required to drive his or her vehicle onto the first conveyor 34, whereupon the vehicle can be caused to travel around the facility 22 to the drive-through window 24 by suitable actuation, in sequence, of the conveyors 34, 36 and 38. With reference to FIG. 2, actuation of the conveyors is accommodated by a belt drive system 40. A belt cleaning system 48 is provided for each belt, to remove soil therefrom and ensure smooth operation.

Returning to FIG. 1, for Northern climates, internal belt de-icing wires, i.e. heating elements 50, are provided, to remove ice and snow, for the same smooth operation.

Each communication device 28 is mounted for movement on a rail 52 for generally parallel movement to and in concert with at least one of the conveyor 34,36,38 to permit, in use, an occupant of a vehicle in motion on the transport device 26 to communicate, i.e. relay an order to, the restaurant facility 22. This could be via a microphone/speaker arrangement, with communication occurring verbally between the driver and an employee of the facility or a remote call center or between the driver and an automated attendant with voice recognition and speech generation functionality. Alternatively, other communication devices, such as touch screens could be employed.

The sensors 30 are arrayed at points intermediate the receiving area 42 and the drive-through window 24 to detect the locations of vehicles located on the transport device 26.

The logic controller 32 communicates with the sensors 30 and is adapted to actuate the conveyors 34, 36, 38 to transport vehicles from the receiving area 42 to the drive-through window 24 at independently variable rates of speed to permit vehicles to be turned off at the receiving area while maintaining a flow of vehicles, spaced-apart from one another, to the drive-through window 24. Similarly, the logic controller communicates with a respective motor [not shown] associated with each communication device 28, to propel the communication device 28 alongside the vehicle on the first conveyor 34 for order acceptance. The manner in which such a logic controller 32 could be built is a matter of routine to persons of ordinary skill in the art, and as such, is not described herein in detail.

It will be evident that this arrangement provides a drive-through restaurant 20 which is characterized by reduced emissions from vehicles utilizing the drive through and a reduced incidence of collisions between vehicles traveling through the drive-through.

The apparatus, of course, has application outside the field of drive-through restaurants.

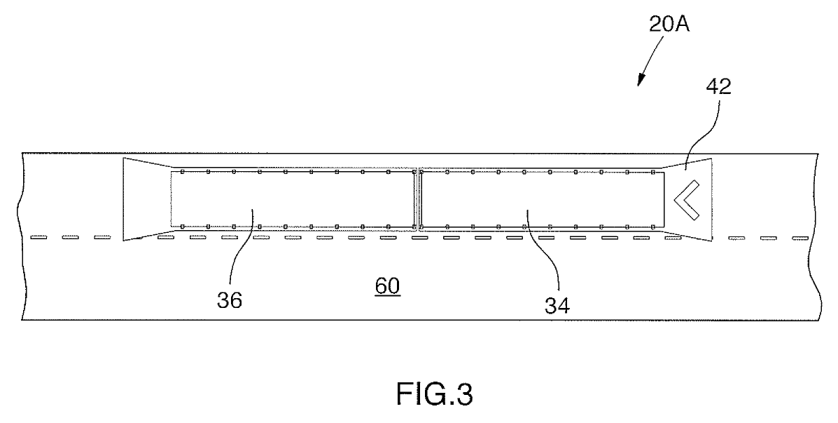

FIG. 3 shows a further specific embodiment, namely, a two conveyor 34,36 embodiment 20A employed to channel traffic through a construction zone 60. A similar arrangement (not shown) could be employed to transport vehicles through a tunnel or across a bridge.

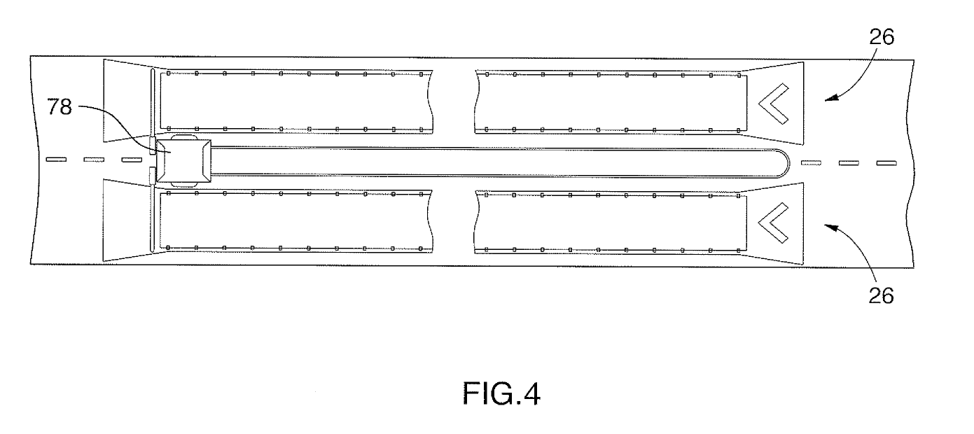

FIG. 4 shows a further specific embodiment wherein a pair of transport devices 26 are deployed to lead up to a toll both 70.

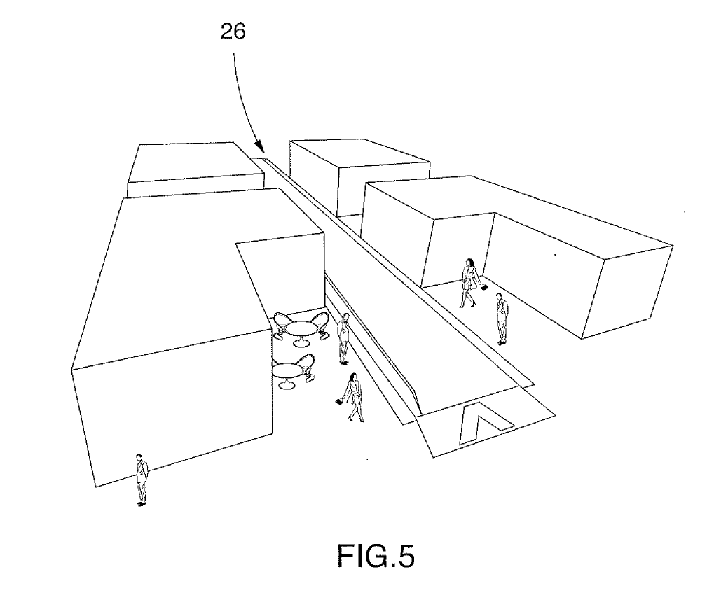

FIG. 5 shows a further specific embodiment, wherein a transport device is utilized to transport vehicles across a pedestrian plaza. A similar arrangement could be employed in environmentally delicate or important areas.

In each embodiment, the apparatus provide advantage in terms of improved safety to throughpassing vehicles and bystanders and the surrounding environment, and in terms of reduced localized vehicular emissions.

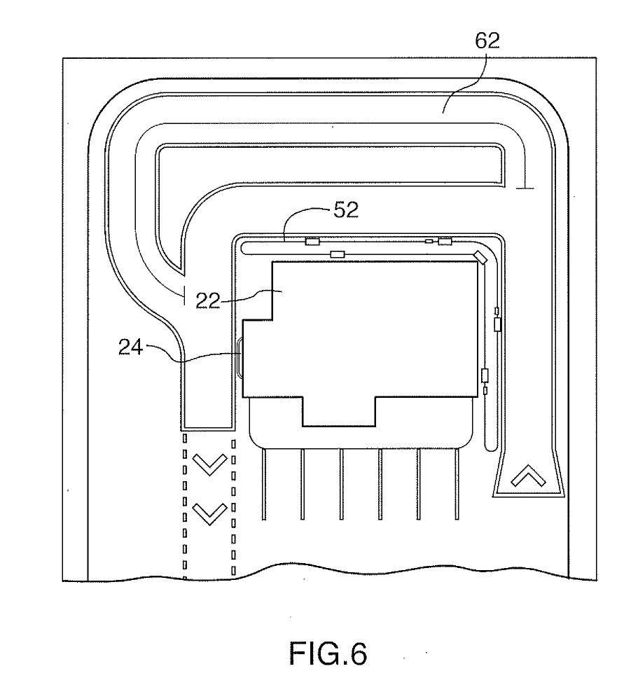

Yet further embodiments are possible. FIG. 6 shows a variation of the structure of FIG. 1, but additionally including a waiting lane 62, to provide two streams of vehicles, for improved flexibility in terms of vehicular throughput.

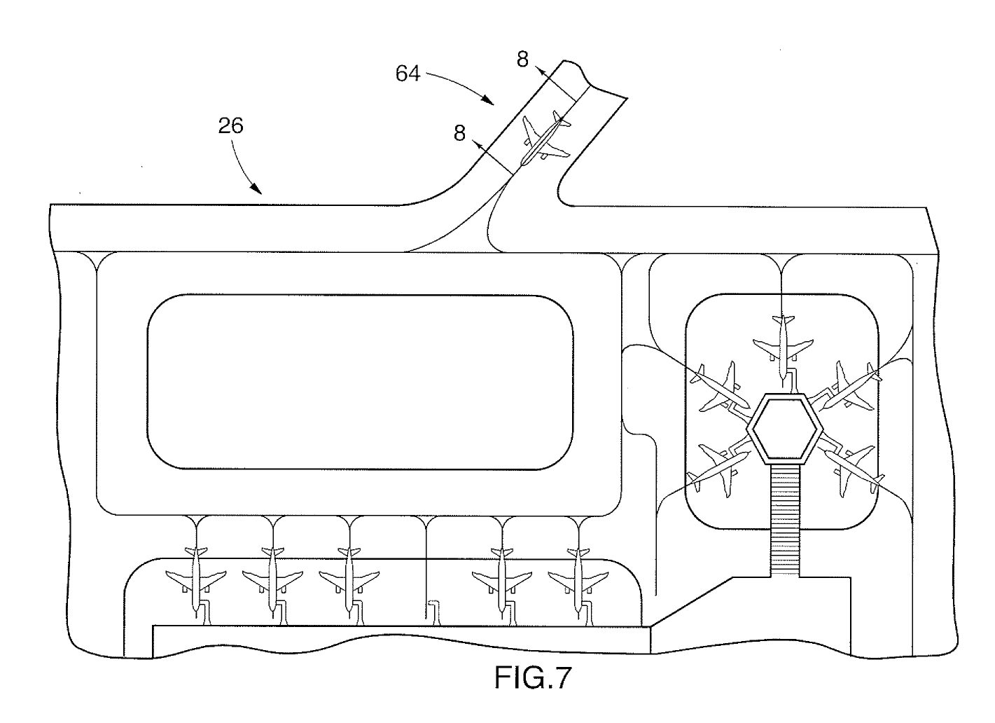

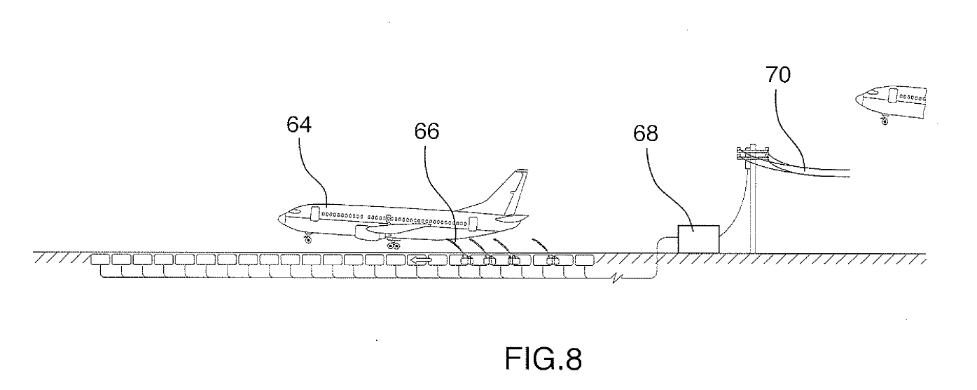

A further variation is shown in FIGS. 7 and 8, wherein the transport device 26 is deployed to shuttle aircraft 64 between the runways and the aircraft loading areas. In this embodiment, an arrester hook 66, of the type used on aircraft carriers, is provided and secured to the transport device 66, so that the energy from the aircraft that would otherwise be wasted as heat during braking is recovered, in the same way that a hybrid vehicle recovers energy during braking, transformed in a transformed 68 and delivered to the electric grid 70 or a battery bank.

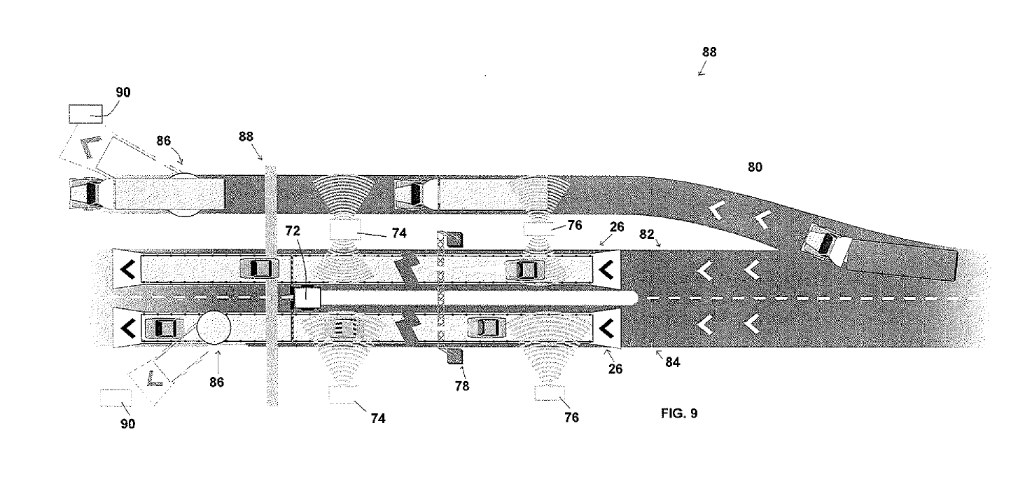

Another variation is shown in FIG. 9. In this variation, a pair of transport devices 26, each with multiple conveyors (not specifically identified), are deployed at a border crossing 88, in combination with a guard booth 72, X-ray units 74, explosive detectors 76, a high-resolution camera system 78. Incoming truck and other large vehicle traffic is directed to truck lane 80. Smaller vehicle traffic passes to lanes 82,84, each having associated therewith a respective one of the transport devices 26. The transport devices 26 avoid idling, as per the other examples, and allow the throughpassing vehicles to be brought to a stop at the guard booth for time periods that vary, depending with the time needed by the guard to carry out a proper search/analysis of the vehicle in question. FIG. 9 also shows swing ramps 86, which enable cars and trucks to be diverted to other conveyors, for detailed searches, etc. Various of the operations of this arrangement could be controlled via automation, with scanners being used to trigger many operations. For commercial trucks carrying GPS transmitters, the operations could be automated in combination with a GPS receiver, that sensed the arrival of the vehicle in question. If, for example, the vehicle had been pre-cleared elsewhere and had not come to a stop since the last search and the border, the vehicle could be permitted to bypass secondary (detailed) border inspection; otherwise, the vehicle could be directed to a security search area 90.

As well, whereas conveyor belts are illustrated and described in detail, it should be understood that other forms of conveyors could be employed. A plurality of rollers could, for example, be utilized. Similarly, chain conveyors which drag a vehicle via the capture of one or more of its tires, such as are well-known in the car wash industry, could be employed, as could vehicle shuttles, whether they be mounted on rail or otherwise maneuverable, for example, by magnetic levitation technology.

As well, whereas heating elements are shown, other arrangements could be adopted to address cold climate use, such as overhead shelters.

Further, whereas the communication device shown is rail-mounted, other mechanisms for moving the communication device could be employed. For example, and without limitation, where the transport device was defined by individual vehicle shuttles, as discussed above, individual communication devices could be fixedly mounted to each.

Of course, communication devices can be omitted entirely, if advance communication is not contemplated, or if order-taking were accomplished via other methodologies, for example, if the establishment elected instead to receive orders by telephone, text-message or the like. In further regard to the communication device, it should be appreciated that, when a stationary communication device is employed in a drive-through restaurant according to the present invention, the pinch point associated with the communication device will be its fixed location. In contrast, when a mobile communication device is employed, the pinch point will be defined by the location of the communication device as it moves; notwithstanding that the pinch point in this case moves, it remains a pinch point, that is, a location whereat the speed of vehicular travel is constrained, since the speed of the conveyor and communication device must be such that the order can be given while the vehicle is adjacent the rail, or otherwise within the field of motion of the communication device.

As a further option, the costs associated with the construction and operation of the transport device could be borne by large-scale producers of greenhouse gases, who, in exchange for bearing said costs, could be provided advertisement space along the drive-through roadway.

In view of the various modifications possible, it should be understood that the invention is to be limited only by the accompanying claims, purposively construed.

1. A drive-through establishment comprising:
a facility having a service area; and
a transport device for receiving vehicles and conveying same towards the service area, the transport device comprising one or more conveyors.

2. An establishment according to claim 1, further comprising:
a communication device that moves generally parallel to and in concert with one of the one or more conveyors to permit, in use, an occupant of a vehicle in motion on said one conveyor to communicate with the facility.

3. An establishment according to claim 2, wherein the communication device is rail-mounted.

4. An establishment according to claim 1, wherein the transport device comprises multiple conveyors, each being independently actuable at an independently-variable rate of speed.

5. An establishment according to claim 1, wherein the facility is a retail facility and the service area is defined by a service window.

6. An establishment according to claim 5, wherein the retail facility is a fast-food restaurant and the service window is a take-out window.

7. An establishment according to claim 1, wherein the one or more conveyors are conveyor belts.

8. An establishment according to claim 1, wherein the facility is a border crossing and the service area is defined by a customs booth.

9. An establishment according to claim 1, wherein the service area is defined by a toll booth.

10. A drive-through establishment of the type:
having a vehicle receiving area whereat a stream of vehicles arrive, randomly spaced-apart from one another in time; and
having a pinch point to which vehicles travel from the vehicle receiving area and whereat the speed of vehicular travel is constrained;
the establishment comprising:
a transport device adapted to transport vehicles, in use, from the receiving area to the pinch point at independently variable rates of speed to permit vehicles to be turned off at the receiving area while maintaining a flow of vehicles, spaced-apart from one another, to the pinch point.

11. A drive-through establishment according to claim 10, wherein:
sensors are arrayed at points intermediate the receiving area and the pinch point to detect the locations of vehicles; and a logic controller in communication with the sensors drives the transport device to avoid collisions of vehicles in transport.

12. A drive-through establishment according to claim 10, wherein the pinch point is defined by a service window in a retail establishment.

13. Apparatus for use in an area of vehicular traffic, said area being of the type:
having a vehicle receiving area whereat a stream of vehicles arrive, randomly spaced-apart from one another in time;
having a first pinch point to which vehicles travel from the vehicle receiving area and whereat the speed of vehicular travel is constrained; and
having a second pinch point to which vehicles travel from the first pinch point and whereat the speed of vehicular travel is constrained,
the apparatus comprising:
a transport device adapted to transport vehicles from the receiving area to the second pinch point at independently variable rates of speed to permit the vehicles to be turned off at the receiving area while maintaining a flow of vehicles, spaced-apart from one another, to the second pinch point.

14. A drive-through establishment comprising:
a communication device;
a facility having a service window and in communication with the communication device to receive orders therefrom; and
apparatus according to claim 13 in use such that the communication device defines the first pinch point and the service window defines the second pinch point.

15. A drive-through establishment according to claim 14, wherein the transport device comprises more than one conveyor.

16. A drive-through establishment according to claim 15, wherein each conveyor is independently actuable at an independently-variable rate of speed.

17. A drive-through establishment according to claim 15, wherein the conveyors are conveyor belts.

18. A drive-through establishment according to claim 15, wherein the communication device moves generally parallel to and in concert with one of the one or more conveyors to permit, in use, an occupant of a vehicle in motion on said one conveyor to communicate with the facility.

19. A drive-through establishment according to claim 18, wherein the communication device is rail-mounted.

20. A drive-through establishment according to claim 15, wherein sensors are arrayed along the conveyors to detect the locations of vehicles and a logic controller in communication with the sensors drives the conveyors to avoid collisions of vehicles in transport.

21. Apparatus for use in an area of vehicular traffic, said area being of the type:
having: a vehicle receiving area whereat a stream of vehicles arrive, randomly spaced-apart from one another in time; and a point to which vehicles travel from the vehicle receiving area,
wherein the speed of vehicular travel is constrained between the vehicle receiving area and the point,
the apparatus comprising:
a transport device adapted to transport vehicles from the receiving area to the point at independently variable rates of speed to permit the vehicles to be turned off at the receiving area while maintaining a flow of vehicles, spaced-apart from one another, to the point.

22. Use of the apparatus of claim 21 in a construction zone.

23. Use of the apparatus of claim 21 in a tunnel.

24. Use of the apparatus of claim 21 on a bridge.

25. Use of the apparatus of claim 21 in a pedestrian plaza.
